(19) United States
(12) Patent Application Publication
(10) Pub. No.: US 2011/0170156 A1
(43) Pub. Date: Jul. 14, 2011

(54) OPTICAL SCANNING DEVICE, IMAGE DISPLAY DEVICE AND METHOD OF DRIVING OPTICAL SCANNING DEVICE

(75) Inventor: Haruhisa TAKAYAMA, Nagoya-shi (JP)

(73) Assignee: BROTHER KOGYO KABUSHIKI KAISHA, Nagoya-shi (JP)

(21) Appl. No.: 13/053,813

(22) Filed: Mar. 22, 2011

Related U.S. Application Data
(63) Continuation-in-part of application No. PCT/JP2009/056242, filed on Mar. 27, 2009.

(30) Foreign Application Priority Data
Sep. 25, 2008 (JP) 2008-246207

(51) Int. Cl. G02B 26/10

(52) U.S. Cl. 359/213.1

(57) ABSTRACT

An optical scanning device includes: a reflection part which is configured to scan a light beam by swinging; a drive part which is configured to generate a drive waveform for swinging the reflection part; a waveform information storage part which is configured to store a plurality of waveform informations used for the generation of the drive waveform; a drive waveform setting part which is configured to select one waveform information from the plurality of waveform informations, and is configured to set the drive waveform; and a detection part which detects an amount of ringing which is superimposed on swinging of the reflection part, wherein the drive waveform setting part sequentially supplies the plurality of waveform informations stored in the waveform information storage part to the drive part, and selects the waveform information with which the amount of ringing detected by the detector becomes smaller than a predetermined value.

### CROSS-REFERENCE TO RELATED APPLICATIONS

The present application is a Continuation-in-Part of International Application PCT/JP2009/056242 filed on Mar. 27, 2009, which claims the benefits of Japanese Patent Application No. 2008-246207 filed on Sep. 25, 2008.

### BACKGROUND

1. Field

The present invention relates to an optical scanning device used for scanning a light beam, and more particularly to an image display device which forms a projection image by scanning a light beam two-dimensionally.

2. Description of the Related Art

An optical scanning device has been used as an optical scanner of a copying machine or a printer or an optical scanner for a projection device. FIG. 11A is a schematic view showing the manner of operation in which this type of optical scanning device 100 performs optical scanning. A reflection surface is formed on a surface of a reflection part 101. A light beam from a light source 103 is irradiated to the reflection surface of the reflection part 101. On a back surface of the reflection part 101 on which a reflection surface is not formed, a coil not shown in the drawing is formed, for example, and a magnet is arranged on the periphery of the reflection part 101. By supplying a drive signal formed of an AC current to the coil, a Lorentz force is applied to a current path clue to a Fleming's left hand rule so that the reflection part is swung about a swing axis. Due to the swing of the reflection part, a light beam which is incident on the reflection surface is scanned as a scanned light at the time of reflection. A drive signal whose intensity is modulated in response to an image signal, for example, is supplied to the light source 103 from a drive circuit 102 so that the light source 103 repeats turn-on and turn-off thereof. By driving the swinging of the reflection part 101 and the turn-on and the turn-off of the light source 103 in a synchronized manner, an image can be displayed by scanned light which is reflected from the reflection part 101.

FIG. 11B shows one example of a drive signal for driving the reflection part 101, and expresses vertical scanning when an image is projected by two-dimensional scanning. Time is taken on an axis of abscissas, and amplitude of an electric current is taken on an axis of ordinates. Amplitude of the drive signal has a cyclic sawtooth shape with respect to time. FIG. 11C expresses a swing state of the reflection part 101. Time is taken on an axis of abscissas, and a mirror angle of a reflection surface is taken on an axis of ordinates. The mirror angle is oscillated cyclically in a sawtooth shape with reference to a horizontal state where a drive signal is not applied to the reflection part.

However, as indicated by a partially enlarged view indicated by an arrow in FIG. 11B, ringing formed of minute oscillations is superimposed on the mirror angle. When the ringing formed of minute oscillations is superimposed on the mirror angle, a cycle of the minute oscillations is superimposed on a scanned light so that irregularities are superimposed on a scanning speed. When an image display is performed using the optical scanning device, the irregularities constituted of coarse portions and dense portions appear also with respect to scanning lines of an image to be displayed thus deteriorating image quality.

The ringing shown in the enlarged partial view in FIG. 11C is generated due to the following reason. In the optical scanning device 100 shown in FIG. 11A, the reflection part 101 is supported on a support portion. When the reflection part 101 is rotated, a restoring force which is intended to restore the reflection part 101 to an original position against the rotation of the reflection part 101 works due to the torsional elasticity of the support portion which supports the reflection part 101. Accordingly, intrinsic oscillations determined based on the moment of inertia of the reflection part 101 and the torsional elasticity of the support portion are generated. Further, even when the structure shown in FIG. 11A is not used, when a restoring force which is intended to restore the reflection part 101 to an original position mechanically, electrically or magnetically against the rotation of the reflection part 101 works, intrinsic oscillations are generated.

On the other hand, as shown in FIG. 11B, when the optical scanning device is used for vertical scanning of a two-dimensional image display, a drive signal is linearly increased during a scanning period in which an image is displayed, and the drive signal is sharply changed when a period is shifted from the scanning period to a retracing period in which an image is not displayed or when a period is shifted from the retracing period to the scanning period. That is, the drive signal is sharply changed in the vicinity of the peak of the sawtooth shape. This sharp change of the drive signal gives an impact to the reflection part 101 so that intrinsic resonance oscillations are induced in the reflection part 101. Once the resonance oscillations are generated in the reflection part 101, the resonance oscillations continue for a while unless a drive signal which cancels the resonance oscillations is supplied. For example, when an optical scanning device is applied to vertical scanning in an image display device, the resonance oscillations continue for 1 frame time or more thus bringing about the deterioration of quality of a projected image.

JP-A-54-89673 (patent document 1) discloses a technique which decreases this kind of ringing which is generated when a sawtooth-shape drive current is supplied to a galvano mirror by applying a step-like pulse during a retracing period of a drive current. Further, patent document 1 discloses that the ringing can be suppressed by properly selecting a pulse width or a pulse height of the step-like pulse. JP-A-2005-338450 (patent document 2) discloses a system for driving a galvano-type scanner, wherein a plurality of drive patterns for driving a galvano-type scanner is stored in a ROM, and even when the displacement occurs at the time of actual use with respect to a preset drive pattern, it is possible to cope with the displacement by selecting the drive pattern and hence, it is unnecessary to connect an expensive command generator to the system from the outside.

### SUMMARY

However, in this type of optical scanning device, it is difficult to make the characteristic uniform at the time of manufacture so that irregularities are found in the characteristics whereby it is not easy to decrease ringing. Further, along with a change in a surrounding environment or a change in the optical scanning device with time such as a change in the modulus of torsional elasticity of a support portion which supports a reflection part, for example, a resonance frequency and amplitude of ringing are changed with time. Accordingly, even when ringing is suppressed in initial setting, ringing is increased when the optical scanning device is continuously used. Further, there has been a case where ringing is increased in the same manner also when an environmental changes such as when a temperature change takes place.

Accordingly, it is an object of the present invention to provide an optical scanning device, an image display device and a method of driving an optical scanning device in which, even when irregularities occur in an initial characteristic of a reflection part or an oscillation characteristic is changed with time so that undesired ringing is induced or increased, by selecting one of a plurality of drive waveforms, an amount of ringing can be controlled to a predetermined value or less.

To achieve the above-mentioned object, according to one aspect of the present invention, there is provided an optical scanning device which includes: a reflection part which is configured to scan a light beam by swinging; a drive part which is configured to generate a drive waveform for swinging the reflection part; a waveform information storage part which is configured to store a plurality of waveform informations used for the generation of the drive waveform; a drive waveform setting part which is configured to select one waveform information from the plurality of waveform informations, and is configured to set the drive waveform based on the selected waveform information; and a detection part which is configured to detect an amount of ringing which is formed of undesired oscillations contained in the swinging of the reflection part, wherein the drive waveform setting part sequentially supplies the plurality of waveform informations stored in the waveform information storage part to the drive part, and selects the waveform information with which the detected amount of ringing becomes smaller than a predetermined value.

To achieve the above-mentioned object, according to another aspect of the present invention, there is provided an image display device which includes: a low-speed optical scanning device having: i) a reflection part which is configured to scan a light beam by swinging; ii) a drive part which is configured to generate a drive waveform for swinging the reflection part; iii) a waveform information storage part which is configured to store a plurality of waveform informations used for the generation of the drive waveform; iv) a drive waveform setting part which is configured to select one waveform information from the plurality of waveform informations, and is configured to set the drive waveform based on the selected waveform information; and v) a detection part which is configured to detect an amount of ringing which is formed of undesired oscillations contained in the swinging of the reflection part, wherein the drive waveform setting part sequentially supplies the plurality of waveform informations stored in the waveform information storage part to the drive part, and selects the waveform information with which the detected amount of ringing becomes smaller than a predetermined value; a high speed optical scanning device; a light source which is configured to generate a light beam whose intensity is modulated based on an image signal and is configured to irradiate the light beam to the optical scanning device; and a projection lens system which is configured to project the light beam scanned by the optical scanning device.

To achieve the above-mentioned object, according to still another aspect of the present invention, there is provided a method of driving an optical scanning device which comprises: a reflection part which is configured to scan a light beam by swinging; a drive part which is configured to generate a drive waveform for swinging the reflection part; a waveform information storage part which is configured to store a plurality of waveform informations used for the generation of the drive waveform; a drive waveform setting part which is configured to select one waveform information from the plurality of waveform informations, and is configured to set the drive waveform by supplying the selected waveform information to the drive part; and a detection part which detects an amount of ringing based on oscillations superimposed on the swinging of the reflection part, the method including the steps of reading the plurality of waveform information stored in the waveform information storage part;

swinging the reflection part by supplying the read waveform information to the drive part; comparing the amount of ringing detected by the detection part and a predetermined value and selecting the waveform information when the detected amount of ringing becomes smaller than the predetermined value; and driving the reflection part by setting the selected waveform information in the drive part.

### BRIEF DESCRIPTION OF DRAWINGS

FIG. 1 is a view showing the basic constitution of an optical scanning device according to an embodiment of the present invention;

FIG. 2 is a block diagram showing the optical scanning device according to the embodiment of the present invention;

FIG. 3A is an explanatory view of an optical scanner which is used in the optical scanning device according to the embodiment of the present invention;

FIG. 3B is an explanatory view of an optical scanner which is used in the optical scanning device according to the embodiment of the present invention;

FIG. 4A is an explanatory view for explaining a drive waveform for driving the optical scanning device and the swinging of a reflection part according to the embodiment of the present invention;

FIG. 4B is an explanatory view for explaining a drive waveform for driving the optical scanning device and the swinging of the reflection part according to the embodiment of the present invention;

FIG. 4C is an explanatory view for explaining a drive waveform for driving the optical scanning device and the swinging of the reflection part according to the embodiment of the present invention;

FIG. 5 is an explanatory view for explaining a drive waveform for driving the optical scanning device and the swinging of the reflection part according to the embodiment of the present invention;

FIG. 6 is an explanatory view for explaining an operation of a drive waveform setting part of the optical scanning device according to the embodiment of the present invention;

FIG. 7A is an explanatory view for explaining another operation of the drive waveform setting part of the optical scanning device according to the embodiment of the present invention;

FIG. 7B is an explanatory view for explaining another operation of the drive waveform setting part of the optical scanning device according to the embodiment of the present invention;

FIG. 8 is an explanatory view for explaining another operation of the drive waveform setting part of the optical scanning device according to the embodiment of the present invention;

FIG. 9 is a flowchart showing a method of driving the optical scanning device according to the embodiment of the present invention;

FIG. 10 is a view showing the constitution of a retinal scanning display according to the embodiment of the present invention;

FIG. 11A is an explanatory view showing a conventionally known optical scanning device;

FIG. 11B is an explanatory view showing a drive signal used in the conventionally known optical scanning device; and

FIG. 11C is an explanatory view showing a mirror angle in the conventionally known optical scanning device.

### DESCRIPTION

Hereinafter, one embodiment of the present invention is explained in detail in conjunction with drawings.

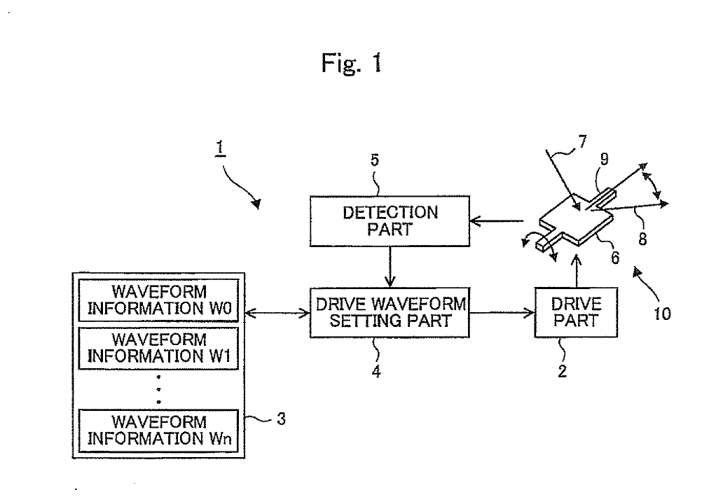

In FIG. 1, an optical scanning device 1 includes a reflection part 6 which converts an incident light beam 7 into a scanned light beam 8, a drive part 2 which drives the reflection part 6, a detection part 5 which detects the swinging of the reflection part 6, a waveform information storage part 3 which stores a plurality of waveform information, and a drive waveform setting part 4 which reads the waveform information from the waveform information storage part 3 and sequentially supplies the waveform information to the drive part 2, detects an amount of ringing by the detection part 5, and selects waveform information with which the detected amount of ringing becomes a value smaller than a predetermined value, and sets a drive waveform based on the selected waveform information. Here, “amount of ringing” means average amplitude or a peak-to-peak value of ringing within a certain range in an effective scanning period which is an effective period out of 1 scanning period in which the incident light beam 7 is scanned by an optical scanner 10.

The reflection part 6 constitutes an oscillation part of the optical scanner 10 explained in detail later. A reflection surface is formed on a surface of the reflection part 6. Swinging is induced in the reflection part 6 due to the torsional rotation imparted to a swing axis 9 or an electrostatic, electromagnetic force or piezoelectric force directly imparted to the reflection part 6. For example, the reflection part 6 can be swung by imparting a torsional rotation about a swing axis 9. Further, the swinging of the reflection part 6 may be induced by a Lorentz force by forming a coil on a back surface of the reflection part 6 opposite to the reflection surface of the reflection part 6, and by supplying an AC current to the coil or by alternating an external magnetic field while applying an external magnetic field to the reflection part 6. Further, the reflection part 6 may be swung by forming a back-surface electrode on the back surface of the reflection part 6, by forming an external electrode outside the reflection part 6 in the vicinity of the back-surface electrode and by applying an AC voltage to either one or both of electrodes.

The drive part 2 generates a drive waveform used for swinging the reflection part 6 based on waveform data supplied by the drive waveform setting part 4. The drive part 2 is constituted of a DA converter and an amplifier, and can generate a drive waveform by receiving the waveform data made of time series data of voltage value from the drive waveform setting part 4 as an input. Further, the drive part 2 may be constituted of a drive waveform generator which generates a drive waveform by setting a parameter value and an amplifier, and the parameter value may be inputted to the drive part 2 as waveform data.

Although the drive waveform differs depending on a usage of the optical scanning device 1, for example, when the optical scanning device 1 is used as an optical scanner for vertical scanning to form a two-dimensional image, the drive waveform has a sawtooth-like or triangular cyclic shape. Such a shape is adopted for swinging the reflection surface of the reflection part 6 at a constant angular speed. However, the drive waveform is not limited to such a shape, and may be a sinusoidal shape or may be other shapes.

The detection part 5 may be constituted of a piezoelectric element which is mounted on the swing axis 9 of the reflection part 6, a beam portion which holds the swing axis 9 or the like, and an amplifying circuit which amplifies an output voltage from the piezoelectric element. The piezoelectric element converts a change in stress into a change in voltage and hence, the piezoelectric element can detect the actual swinging of the reflection part 6. Further, the swinging of the reflection part 6 can be detected using an acceleration sensor. For example, an acceleration sensor may be mounted on a back surface of the reflection part 6. Although the detection sensitivity of the acceleration sensor is lowered when the reflection part 6 is swung at a constant angular speed, acceleration is added to the acceleration sensor when ringing is generated due to minute oscillations in the reflection part 6. Accordingly, the acceleration sensor can be used as a ringing amount detection unit which also performs a filter function of eliminating the swinging at a constant angular speed. Further, the actual swinging of the reflection part 6 can be detected by a photo sensor which is arranged at a position to which a scanning beam reflected from the reflection part 6 is irradiated. That is, it is possible to detect an amount of ringing by arranging a plurality of photo sensors at the position to where a scanning beam is irradiated.

The waveform information storage part 3 stores a plurality of waveform informations for generating a drive waveform. For example, the waveform information storage part 3 stores a plurality of waveform informations which contain frequency components, wherein particular frequency components are suppressed and these frequency components differ from each other. For example, when the resonance frequency of the reflection part 6 becomes irregular in the manufacture of the reflection part 6 or is changed with time, a plurality of changes of the resonance frequency are measured or estimated in advance, and a plurality of waveform informations respectively corresponding to the measured or estimated resonance frequencies are respectively stored in the waveform information storage part 3. For example, a plurality of waveform informations are stored in the waveform information storage part 3 in such a manner that the waveform information is constituted of an output current value or an output voltage value for 1 cycle at each timing of the drive waveform supplied to the reflection part 6 and is associated with frequency of ringing and an amount of ringing. Further, waveform information is constituted of a parameter value corresponding to physical quantity, and the drive waveform is generated based on each parameter value. As the parameter value, for example, frequency of ringing, amplitude of ringing, an ambient temperature, a cumulative time during which the reflection part 6 is operated or the like may be used.

The drive waveform setting part 4 performs selection processing in which waveform information with which the amount of ringing is made smaller than a predetermined value is selected, and setting processing in which a drive waveform which is supplied to the reflection part 6 from the drive part 2 is set based on the selected waveform information. The selection processing is performed as follows. The drive waveform setting part 4 reads waveform information from the waveform information storage part 3 and supplies the waveform data based on the waveform information to the drive part 2. The drive part 2 generates a drive waveform based on the supplied waveform data. The optical scanner 10 is swung based on the generated drive waveform. The detection part 5 detects an amount of ringing of the reflection part 6. When the detected amount of ringing is larger than a predetermined value as a result of comparison between the detected amount of ringing and the predetermined value, the drive waveform setting part 4 reads waveform information which is different from the preceding waveform information from the waveform information storage part 3, and drives the optical scanner 10 by applying a drive waveform generated based on the waveform information. The drive waveform setting part 4 repeats the same above-mentioned processing. When the drive waveform setting part 4 determines that the detected amount of ringing is smaller than the predetermined value, the drive waveform setting part 4 selects this waveform information. Hereinafter, the drive waveform setting part 4 performs the setting processing for driving the optical scanner 10 based on the waveform information.

For example, as the waveform informations to be stored in the waveform information storage part 3, waveform information W0 for restricting the intrinsic resonance at the intrinsic resonance frequency fo of the reflection part 6, and waveform information W1 for restricting the intrinsic resonance at the intrinsic resonance frequency fo+δ (δ indicating frequency) of the reflection part 6 are prepared. In the same manner, waveform information W2 for restricting the intrinsic resonance at the intrinsic resonance frequency fo+2δ of the reflection part 6, . . . , and waveform information Wn for restricting the intrinsic resonance at the intrinsic resonance frequency fo+nδ (n being positive or negative integer) are prepared. The drive waveform setting part 4 reads the waveform information W0 from the waveform information storage part 3, and generates waveform data based on the waveform information W0 and supplies the waveform data to the drive part 2. The drive part 2 generates a drive waveform based on the waveform data and drives the optical scanner 10 using the drive waveform. The drive waveform setting part 4 compares an amount of ringing detected by the detection part 5 and a predetermined value. Next, the drive waveform setting part 4 reads waveform information. W1 from the waveform information storage part 3, compares the detected amount of ringing and a predetermined value in the same manner as described above. This processing is sequentially repeated hereinafter. Then, the drive waveform setting part 4 selects waveform information when the detected amount of ringing becomes smaller than the predetermined value, and drives the optical scanner 10 using a drive waveform generated based on the waveform information hereinafter.

In this case, a quantity that the intrinsic resonance frequency fo changes with time may be estimated as δ and the waveform information corresponding to δ may be stored in the waveform information storage part 3. For example, when the intrinsic resonance frequency slightly changes with time, a value of δ becomes small so that a change of the drive waveform based on the waveform information corresponding to 6 also becomes a slight change. Further, when the intrinsic resonance frequency fo becomes irregular at the time of manufacture of the reflection part 6, (2n+1) pieces or more waveform information may be stored in the waveform information storage part 3 such that a range of irregularities falls within ±nδ. Further, besides the waveform information when the intrinsic resonance frequency changes, the waveform information corresponding to magnitude of an amount of ringing or waveform information corresponding to a temperature change or a driving cumulative time of the reflection part 6 may be stored in the waveform information storage part 3. Further, as the waveform information, a parameter value corresponding to a physical quantity which influences ringing of the reflection part 6 or waveform information which contains a parameter value corresponding to a physical quantity may be used.

The embodiment of the present invention is explained specifically hereinafter.

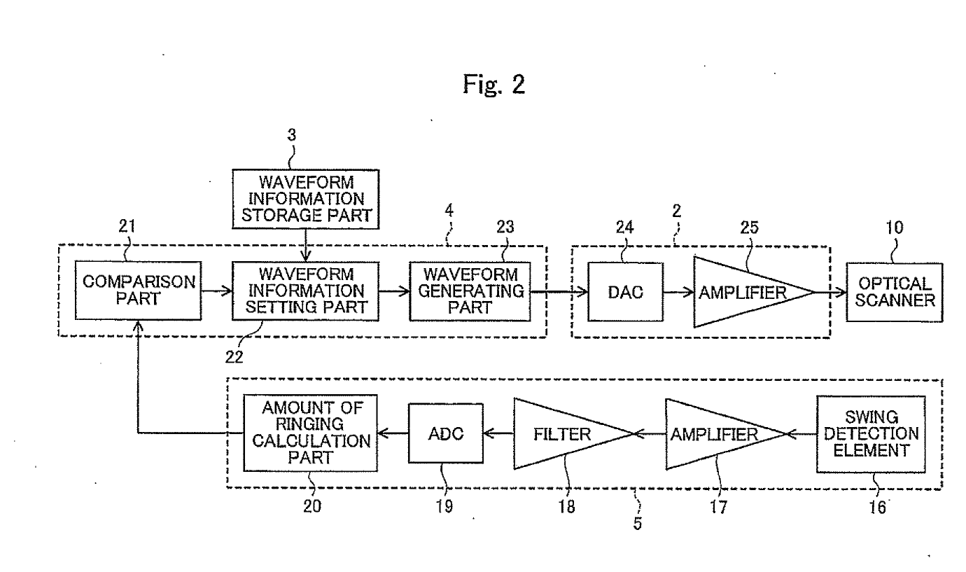

FIG. 2 is a view showing the constitution of the optical scanning device 1 according to the embodiment of the present invention. The drive part 2 which drives the optical scanner 10 is constituted of a DA converter 24 which receives waveform data from the drive waveform setting part 4 as an input and converts the waveform data into an analog waveform, and an amplifier 25 which amplifies the analog waveform from the DA converter 24 and generates a drive waveform. The drive waveform is outputted to the optical scanner 10 so that the reflection part 6 of the optical scanner 10 is swung.

The detection part 5 is constituted of a swing detection element 16 which detects the swinging of the optical scanner 10, an amplifier 17 which amplifies an output signal from the swing detection element 16, a filter 18 which is provided for eliminating, for example, a low frequency component of an output signal of the amplifier 17, an AD converter 19 which converts an output signal from the filter 18 into a digital signal, and a ringing amount calculation part 20 which calculates an amount of ringing based on output data from the AD converter 19. The ringing amount calculation part 20 can calculate, besides the amount of ringing, frequency of the ringing. The swing detection element 16 is a piezoelectric element which is mounted on the support portion which supports the reflection part 6 of the optical scanner 10.

The drive waveform setting part 4 is constituted of a comparison part 21 which compares an amount of ringing inputted from the detection part 5 and a predetermined value, a waveform information setting part 22 which reads waveform information from the waveform information storage part 3 based on a comparison result of the comparison part 21, and selects or sets waveform information, and a waveform generating part 23 which generates waveform data for driving from the set waveform information. The waveform generating part 23 generates, when the waveform information read from the waveform information storage part 3 is constituted of waveform data amounting to 1 cycle, for example, continuous waveform data by connecting the waveform data amounting to 1 cycle. Alternatively, when the read waveform information is a parameter value, the waveform generating part 23 generates waveform data which is specified by the parameter value.

The ringing amount calculation part 20, the comparison part 21, the waveform information setting part 22 and the waveform generating part 23 are realized by executing software. That is, the optical scanning device 1 shown in FIG. 2 includes a control part not shown in the drawing, and the control part includes a CPU, a ROM and a RAM. The CPU reads and executes a program stored in the ROM on the RAM thus realizing the ringing amount calculation part 20, the comparison part 21, the waveform information setting part 22 and the waveform generating part 23 described above. Further, the AD converter 19, the ringing amount calculation part 20 and the comparison part 21 may be constituted of a ringing amount detection circuit and a comparison circuit instead of realizing them by executing software.

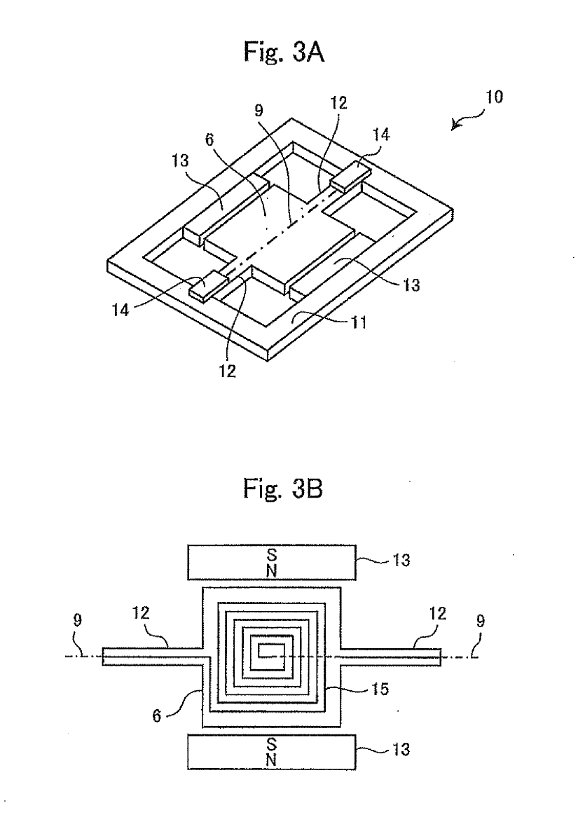

As shown in FIG. 3A and FIG. 3B, the reflection part 6 of the optical scanner 10 has a quadrangular shape and a reflection surface is formed on a surface of the reflection part 6. The reflection part 6 is supported by support portions 12 which are connected to two sides of the reflection part 6 respectively, and the support portions 12 are connected to and supported by a frame 11. That is, the reflection part 6 is swingably supported by the frame 11 by way of two support portions 12.

Permanent magnets 13 are arranged adjacent to two sides of the reflection part 6 respectively parallel to a swing axis 9 of the reflection part 6. A magnetic field of the permanent magnet 13 is parallel to the reflection surface of the reflection part 6 in a stationary state, and is orthogonal to the swing axis 9. A coil 15 is formed on a back surface of the reflection part 6 on a side opposite to the reflection surface. Electrodes of the coil 15 are connected to the outside by way of two support portions 12. Due to such a constitution, when an electric current is supplied to the coil 15, a Lorentz force acts on the coil 15. The Lorentz force acts toward a side above a paper plane of the drawing with respect to a lower half of the coil 15 from the swing axis 9 and the Lorentz force acts toward a side below the paper plane of the drawing with respect to an upper half of the coil 15 from the swing axis 9 so that a rotational torque is generated in the reflection part 6 about the swing axis 9. Accordingly, it is possible to control a swing angle of the reflection part 6 by controlling magnitude of an electric current.

Piezoelectric elements 14 for detecting the swinging of the reflection part 6 are mounted on the support portions 12 respectively. When the reflection part 6 is swung, torsion is generated in the support portions 12 so that a stress is applied to the piezoelectric elements 14. The piezoelectric element 14 generates a voltage corresponding to an applied stress and hence, it is possible to easily detect amplitude and a cycle of swinging of the reflection part 6 by detecting a change of the voltage.

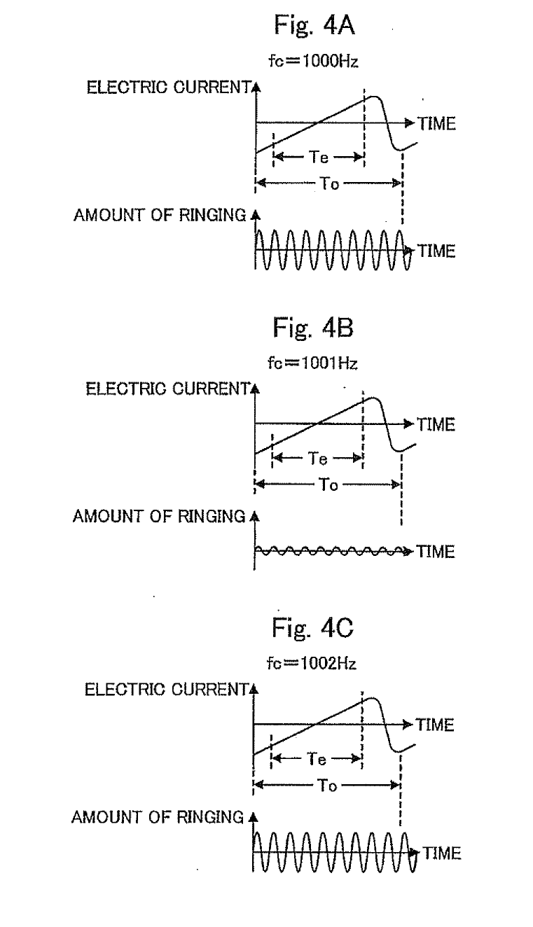

As shown in FIG. 4A to FIG. 4C, in this embodiment, with respect to a drive waveform for driving the reflection part 6, a specific frequency fc to be suppressed for setting an amount of ringing smaller than a predetermined value in advance (hereinafter referred to as “suppression frequency fc”) is changed thus decreasing ringing of the reflection part 6.

FIG. 4A shows a case where the specific suppression frequency fc corresponding to the waveform information is set to 1000 Hz. A graph at an upper stage of FIG. 4A shows a drive waveform supplied to the coil 15 of the reflection part 6, wherein an electric current applied to the coil 15 is taken on an axis of ordinates and time is taken on an axis of abscissas. A graph at a lower stage of FIG. 4A shows oscillations caused by ringing of the reflection part 6 in an exaggerated manner, wherein a displacement quantity of ringing, that is, an amount of ringing is taken on an axis of ordinates and time is taken on an axis of abscissas.

The drive waveform is supplied to the reflection part 6 in such a manner that waveform information stored in the waveform information storage part 3 is read, a waveform is generated by the waveform generating part 23, and the drive part 2 outputs the drive waveform based on the generated waveform 1000 Hz is set in the waveform information as the suppression frequency fc for suppressing an amount of ringing. That is, a drive waveform generated from the waveform information means that either a component of suppression frequency fc of 1000 Hz is eliminated or decreased.

As shown in a graph at an upper stage of FIG. 4A, the drive waveform has a sawtooth shape with a cycle To, and frequency of the drive waveform is set to 60 Hz, for example. The drive waveform is increased substantially monotonically from a negative maximum current to a positive maximum current and, thereafter, is sharply changed to the negative maximum current. Then, the drive waveform returns to an original state. In this drive waveform, the above-mentioned component of the suppression frequency fc is eliminated or decreased and hence, a change point of the waveform becomes slightly gentle or smooth. Further, during a period in which the drive waveform is monotonically increased from the negative maximum current to the positive maximum current, an effective scanning period Te is set. When the optical scanning device 1 is used as a vertical scanning device in an image display device, a projection image is projected during the effective scanning period Te. Accordingly, by decreasing an amount of ringing in the effective scanning period Te, it is possible to prevent the lowering of quality of the projection image.

The amount of ringing is expressed by magnitude (peak to peak) of a swing angle of the reflection part 6. As shown in a lower stage of FIG. 4A, when the suppression frequency fc is set to 1000 Hz as the waveform information, the amount of ringing of the reflection part 6 with respect to the swing angle of the reflection part 6 is 1%. This shows a state where the resonance frequency of the ringing of the reflection part 6 and the suppression frequency fc which suppresses the ringing are displaced from each other.

In FIG. 4B, the waveform information read from the waveform information storage part 3 is changed such that the suppression frequency fc for suppressing the amount of ringing contained in the drive waveform is set to 1001 Hz. Although the drive waveform shown in an upper stage of FIG. 4B is hardly changed from the drive waveform shown in FIG. 4A in appearance, the suppression frequency fc which is eliminated from the drive waveform or is decreased is shifted to a high frequency side by an amount of 1 Hz. On the other hand, as shown in a lower stage of FIG. 4B, the amount of ringing of the reflection part 6 with respect to the swing angle of the reflection part 6 is 0.1%. This shows a state where the resonance frequency at which the ringing of the reflection part 6 is generated and the suppression frequency fc for suppressing the ringing agree with each other so that the ringing is effectively suppressed.

In FIG. 4C, the waveform information read from the waveform information storage part 3 is changed such that the suppression frequency fc for suppressing the amount of ringing contained in the drive waveform is set to 1002 Hz. Although the drive waveform shown in an upper stage of FIG. 4C is hardly changed from the drive waveform shown in FIG. 4A in appearance, the suppression frequency fc which is eliminated from the drive waveform or is decreased is shifted to a high frequency side by an amount of 2 Hz. On the other hand, as shown in a lower stage of FIG. 4C, the amount of ringing of the reflection part 6 with respect to the swing angle of the reflection part 6 is 1%. This shows a result caused by the displacement between the resonance frequency of the ringing of the reflection part 6 and the suppression frequency fc for suppressing the ringing.

The waveform information storage part 3 stores the drive waveforms shown in FIG. 4A to FIG. 4C by an amount corresponding to 1 cycle To. For example, the waveform information storage part 3 stores current values corresponding to the respective timings. In this case, for example, the waveform information storage part 3 stores a plurality of drive waveforms obtained by changing the suppression frequency fc for suppressing the amount of ringing for every 1 Hz as the waveform information. The waveform information setting part 22 specifies the waveform information, reads the specified waveform information amounting to 1 cycle To from the waveform information storage part 3 and transmits the specified waveform information to the waveform generating part 23, and the waveform generating part 23 transmits the continued waveform data to the DA converter 24. Although the suppression frequency fc is set to 1000 Hz to 1002 Hz in FIG. 4A to FIG. 4C, the suppression frequency fe is not limited to these values. The suppression frequency fc may take any arbitrary value with which the amount of ringing can be decreased, and may be a frequency with a change quantity to be changed of 1 Hz or more.

Further, the waveform information storage part 3 may store a plurality of suppression frequencies fc for suppressing the amount of ringing as parameter values in place of storing 1 cycle To of the drive waveform. The waveform information setting part 22 may specify a parameter value which constitutes waveform information, may read the specified parameter value from the waveform information storage part 3 and may transmit the specified parameter value to the waveform generating part 23, and the waveform generating part 23 may generate waveform data based on the parameter value, and may transmit the waveform data to the DA converter 24. Further, the suppression frequency fe for suppressing the amount of ringing may be stored in the waveform information storage part 3 in an associated manner with a physical quantity such as, for example, a temperature change of an environment, a cumulative operation time of the optical scanner 10 or a profile shape of the reflection part 6, and a drive waveform may be generated by setting the physical quantity.

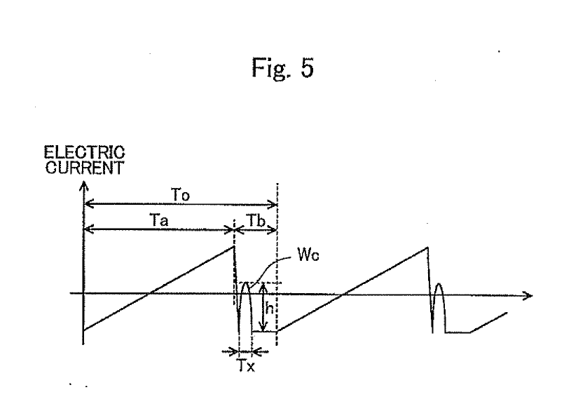

FIG. 5 shows another example of the drive waveform for driving the optical scanner 10 which is a modification of the waveforms shown in FIG. 4A to FIG. 4C. In this modification, a correction waveform Wc is generated in a retracing period of the drive waveform, and a plurality of drive waveforms in which the correction waveform Wc is changed are prepared, and the drive waveforms are sequentially changed over thus suppressing the ringing.

In FIG. 5, an electric current which is supplied to the coil 15 of the reflection part 6 is taken on an axis of ordinates, and time is taken on an axis of abscissas. During a scanning period Ta, an electric current is increased substantially monotonically from a negative maximum value to a positive maximum value. After entering a retracing period Tb, an electric current is rapidly inverted and assumes a negative maximum value, and the correction waveform Wc having a sinusoidal half cycle is supplied with reference to the negative maximum value and, thereafter, an electric current having a negative maximum constant value is supplied. The correction waveform Wc is a waveform during a period Tx which is a half cycle. The scanning period Ta and the retracing period Tb constitute 1 cycle To. The drive part 2 supplies this drive waveform to the optical scanner 10 in a repeated manner.

The waveform information storage part 3 stores current values at respective timings corresponding to 1 cycle To of the drive waveform shown in FIG. 5. In this case, the waveform information storage part 3 sets the frequency 1/(2Tx) of the correction waveform Wc as the suppression frequency fc, for example, and stores a plurality of drive waveforms in which the suppression frequency fc is slightly changed for every drive waveform as waveform information. Alternatively, the waveform information storage part 3 stores a plurality of drive waveforms in which amplitude h of the correction waveform Wc is slightly changed for every drive waveform as waveform information. The waveform information setting part 22 sequentially reads the stored waveform information and supplies the waveform information to the waveform generating part 23, and the waveform generating part 23 outputs the continuous waveform data corresponding to the respective waveform information to the DA converter 24. That is, the drive waveforms in which the correction waveform Wc is slightly changed for every drive waveform are sequentially supplied to the reflection part 6, and the drive waveform setting part 4 can select the waveform information with which the amount of ringing is made smaller than a predetermined value based on the amount of ringing detected by the detection part 5.

The processing explained in conjunction with FIG. 4A to FIG. 4C may be applied to the particular waveform shown in FIG. 5. That is, in place of the usual sawtooth waveform, the particular waveform shown in FIG. 5 may be adopted as the basic drive waveform, and a plurality of drive waveforms which differ in the suppression frequency fc of suppression components other than the correction waveform Wc with respect to the basic drive waveform may be stored and changed over. Further, a plurality of waveforms which are effective or are considered to be effective for ringing in various states (for example, the waveform shown in FIG. 5) may be stored and changed over without taking an element such as the suppression frequency fc into consideration.

In this manner, at the time of driving the reflection part using the sawtooth-shaped drive waveform or the triangular drive waveform, it is possible to detect the substantial amount of ringing without being influenced by overshooting or the like which occurs due to a sharp change of the drive waveform.

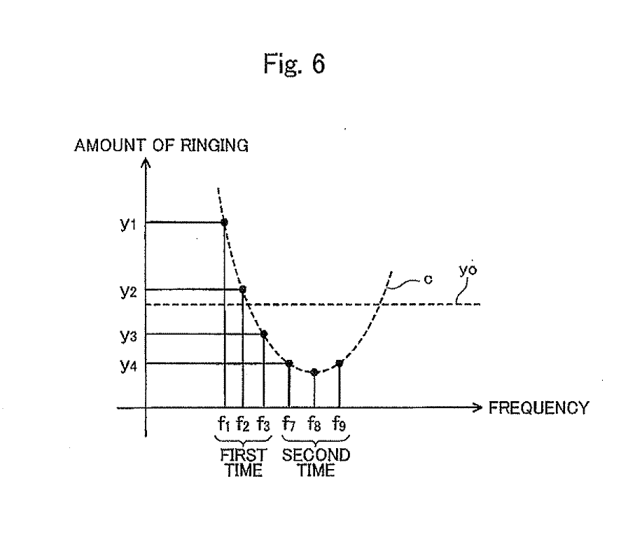

In a graph shown in FIG. 6 which is provided for explaining the manner of operation of the optical scanning device 1 according to the embodiment of the present invention, an amount of ringing detected by the detection part 5 is taken on an axis of ordinates and a parameter value for specifying waveform information stored in the waveform information storage part 3 is taken on an axis of abscissas, wherein the parameter value corresponds to frequency as a physical quantity. To take the drive waveforms shown in FIG. 4A to FIG. 4C and FIG. 5 as an example, the parameter value corresponds to the suppression frequency fc. A predetermined value yo indicates an allowable limit level of the amount of ringing. When a level of the detected amount of ringing is lower than a level of the predetermined value yo, for example, in the case where the optical scanner 10 is applied to an image display device, this level becomes a level at which deterioration of quality of a projection image due to ringing can be ignored.

Firstly, the first setting processing is performed. The drive waveform setting part 4 specifies frequency f1, and reads waveform information corresponding to the frequency f1 from the waveform information storage part 3. The drive waveform setting part 4 generates waveform data from the read waveform information. The drive part 2 generates a drive waveform based on the waveform data and drives the optical scanner 10. The drive waveform setting part 4 compares an amount of ringing y1 detected by the detection part 5 and a predetermined value yo, and determines that the amount of ringing y1 is larger than the predetermined value yo. Then, the drive waveform setting part 4 reads waveform information corresponding to a frequency f2 from the waveform information storage part 3 and generates waveform data, and the drive part 2 generates a drive waveform based on the waveform data and drives the optical scanner 10. The drive waveform setting part 4 compares an amount of ringing y2 detected by the detection part 5 and the predetermined value yo, and determines that the amount of ringing y2 is larger than the predetermined value yo. Hereinafter, the drive waveform is changed sequentially up to a frequency fn, the detected amount of ringing and the predetermined value yo are compared with each other, and this processing is repeated until the amount of ringing becomes smaller than the predetermined value yo. FIG. 6 shows a case where when the optical scanner 10 is driven using the drive waveform based on the waveform information corresponding to the frequency f3, the detected amount of ringing y3 becomes smaller than the predetermined value yo.

Next, the second setting processing is performed. The drive waveform setting part 4 sequentially reads waveform information corresponding to frequencies f7, f8, f9 larger than the frequency f3 from the waveform information storage part 3 and generates waveform data. The drive part 2 sequentially supplies drive waveforms generated based on the waveform data to the optical scanner 10, and the drive waveform setting part 4 sequentially acquires respective ringing quantities detected by the detection part 5. The drive waveform setting part 4 selects waveform information corresponding to the frequency at which the amount of ringing becomes minimum (frequency f8 in FIG. 6) out of the detected ringing quantities. The drive waveform setting part 4 supplies waveform data based on the selected waveform information to the drive part 2 and sets the drive waveform.

For example, in the embodiment shown in FIG. 4A to FIG. 4C, the waveform information in which the frequencies f1 to f9 are changed for every 1 Hz as in the case of 997 Hz to 1005 Hz about the suppression frequency fc=1001 Hz may be stored in the waveform information storage part 3 in advance, and may be sequentially selected in the setting processing of the drive waveforms. Further, for example, amplitude of the suppression frequency fc may be taken on the axis of abscissas in place of frequency, and the amplitude of the suppression frequency fc may be changed. Still further, a temperature may be taken on the axis of abscissas in place of frequency, and the waveform information corresponding to a change of the temperature may be stored in the waveform information storage part 3 in advance, and the temperature may be changed in the setting processing of the drive waveform. In this case, the relationship between the temperature change of the surroundings and the suppression frequency fc may be measured in advance, and the temperature and the suppression frequency fc may be stored in association with each other in the waveform information storage part 3. Further, a cumulative time in which the reflection part 6 is driven my be taken on the axis of abscissas in place of the temperature, waveform information corresponding to a change of the cumulative time may be stored in advance in the waveform information storage part 3, and the cumulative time may be changed in the drive waveform setting processing.

In this manner, the waveform information which is changed with time or corresponding to a surrounding environment may be stored in advance, an amount of ringing which is superimposed on the swing of the reflection part 6 may be detected, and waveform information with which the amount of ringing is lowered is selected thus driving the reflection part 6 with the amount of ringing set smaller than a predetermined value.

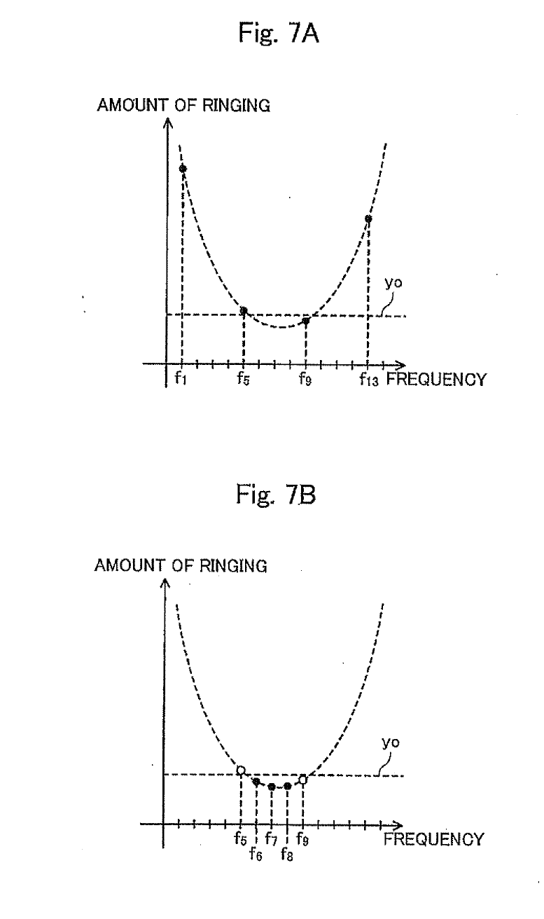

In graphs shown in FIG. 7A and FIG. 7B provided for explaining the manner of operation of an optical scanning device 1 of another embodiment of the present invention, an amount of ringing detected by the detection part 5 is taken on an axis of ordinates, and a parameter value for specifying waveform information stored in the waveform information storage part 3 is taken on an axis of abscissas, wherein frequency, for example, suppression frequency corresponds to the parameter value as a physical quantity. FIG. 7A shows the first setting processing of a drive waveform in which frequency is roughly changed, and FIG. 7B shows the second setting processing of the drive waveform in which the frequency is finely changed.

In the first setting processing, the drive waveform setting part 4 sequentially reads respective waveform information corresponding to frequencies f1, f5, f9, f13 from the waveform information storage part 3, and sequentially supplies waveform data based on the waveform information to the drive part 2, and the drive part 2 drives the optical scanner 10 using drive waveforms generated based on the waveform information corresponding to the respective frequencies. The drive waveform setting part 4 compares ringing quantities detected by the detection part 5 with respect to the respective drive waveforms and a predetermined value yo and specifies two frequencies f5, f9 at which the amount of ringing assumes a minimum value.

In the second setting processing, the drive waveform setting part 4 sequentially reads respective waveform information corresponding to frequencies f6, f7, f8 between the frequency f5 and the frequency 19 from the waveform information storage part 3, and sequentially supplies waveform data based on the waveform information to the drive part 2, and the drive part 2 drives the optical scanner 10 using drive waveforms generated based on the waveform information corresponding to the respective frequencies. The drive waveform setting part 4 compares ringing quantities detected by the detection part 5 with respect to the respective drive waveforms and a predetermined value, selects frequency at which at least the amount of ringing becomes smaller than a predetermined value and assumes a minimum value, and supplies waveform data based on waveform information corresponding to the selected frequency (frequency f7 in this case) to the drive part 2 thus setting the drive waveform. In this manner, the waveform is roughly changed firstly, a parameter value with which the amount of ringing becomes smaller than the predetermined value is specified, the drive waveform is changed more finely, and the drive waveform with which the amount of ringing becomes minimum is selected and hence, the amount of ringing of the reflection part 6 can be rapidly suppressed to a minimum value.

As has been explained previously, in place of using frequency as a parameter value corresponding to a physical quantity, amplitude, a change of surrounding temperature, a cumulative drive time of the reflection part 6 or the like can be adopted.

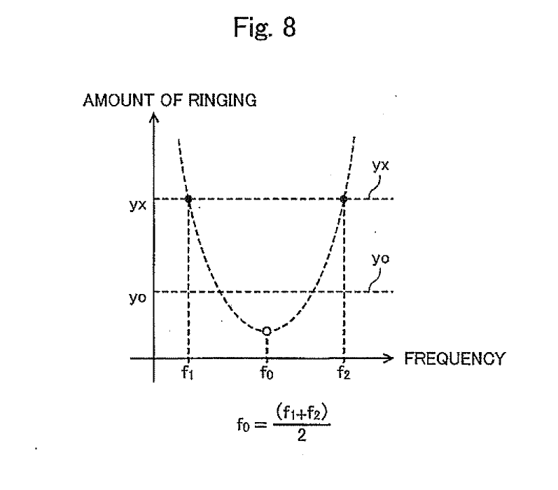

In graphs shown in FIG. 8 provided for explaining the manner of operation of an optical scanning device 1 of another embodiment of the present invention, an amount of ringing detected by the detection part 5 is taken on an axis of ordinates, and a parameter value for specifying waveform information stored in the waveform information storage part 3 is taken on an axis of abscissas, wherein frequency corresponds to the parameter value as a physical quantity.

The drive waveform setting part 4 reads waveform information corresponding to frequency f1 and frequency f2 from the waveform information storage part 3, and supplies waveform data based on the waveform information to the drive part 2, and the drive part 2 generates a drive waveform based on the read waveform information and drives the optical scanner 10. The drive waveform setting part 4, when both of the detected ringing quantities are yx, calculates frequency f0=(f1+f2)/2 and reads waveform information corresponding to the frequency fo from the waveform information storage part 3. When the waveform information corresponding to the frequency fo is not stored, the drive waveform setting part 4 reads the waveform information corresponding to frequency closest to the frequency fo from the waveform information storage part 3. The drive waveform setting part 4 supplies waveform data generated based on the read waveform information to the drive part 2, and the drive part 2 generates a drive waveform and drives the optical scanner 10. The drive waveform setting part 4, upon confirming that the amount of ringing detected by the detection part 5 is smaller than a predetermined value yo, sets the drive waveform based on the waveform information, and the drive part 2 drives the optical scanner 10 and hence, the drive waveform can be set within a short time.

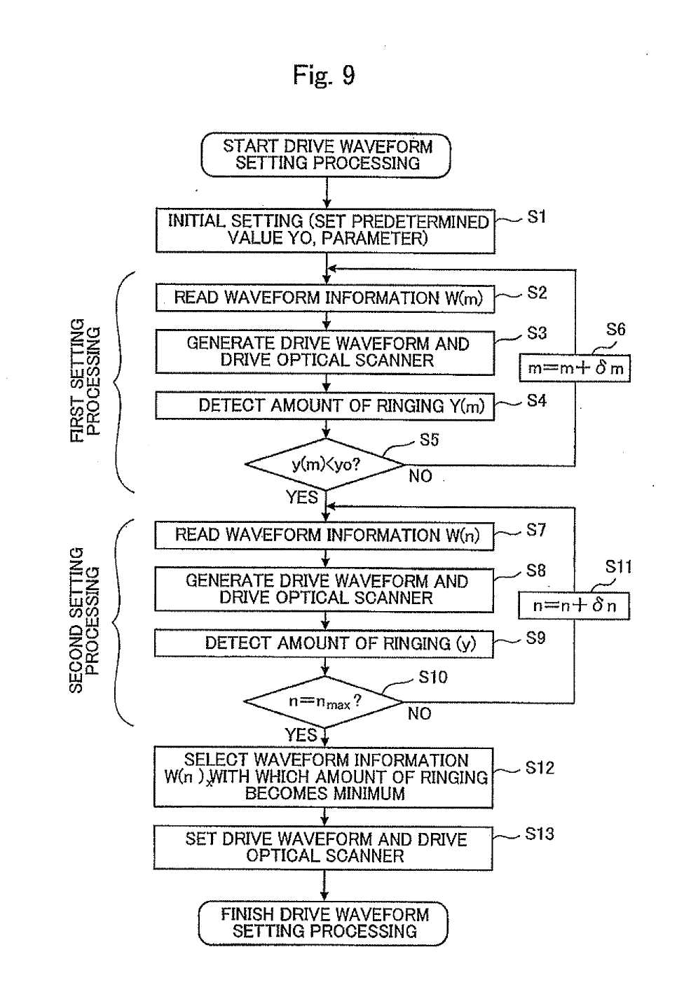

FIG. 9 is a flowchart of drive waveform setting processing of the optical scanning device 1 according to the embodiment of the present invention and expresses a driving method of the optical scanning device 1. The drive waveform setting processing is separated into a group of steps ranging from step S2 to step S6 which constitute the first setting processing and a group of steps ranging from step S7 to step S11 which constitute the second setting processing. A parameter value fx with which the amount of ringing y becomes smaller than the predetermined value yo is obtained in the first setting processing, and a parameter value f with which the amount of ringing y assumes a minimum value is obtained in the second setting processing. Then, the drive waveform is generated based on the waveform information W corresponding to the parameter value f with which the amount of ringing y assumes the minimum value. Hereinafter, the drive waveform setting processing is explained specifically.

The drive waveform setting processing of the optical scanning device 1 is set such that the drive waveform setting processing is automatically started when the driving of the optical scanning display device 1 is started or when predetermined conditions are satisfied during driving. When the drive waveform setting processing is started, the drive waveform setting part 4 performs initial setting under a control by a CPU (step S1). In the initial setting, various settings such as setting of a predetermined value yo indicative of an upper limit of an allowable amount of ringing, setting of a parameter with which a drive waveform for the optical scanner 10 is changed and setting of change widths δm, δn (δm, δn being integers) of parameter values are performed.

First selection processing is performed as follows. The drive waveform setting part 4 reads waveform information W(m) corresponding to a parameter value f(m) (in being a positive integer) from the waveform information storage part 3 (step S2). The drive waveform setting part 4 generates waveform data from the read waveform information W(m) and supplies the waveform data to the drive part 2. The drive part 2 generates a drive waveform by receiving the waveform data as an input and drives the optical scanner 10 (step S3). The detection part 5 detects an amount of ringing y(m) of the reflection part 6 by the swing detection element 16 arranged on the optical scanner 10 (step S4). The drive waveform setting part 4 compares the detected amount of ringing y(m) and a predetermined value yo (step S4). When the detected amount of ringing y(m) is larger than the predetermined value yo (No in step S5), the drive waveform setting part 4 reads a next parameter value f(m) as m=m+δm (step S6). Here, when the parameter value f(m) is to be changed with a minimum width, a change width δm is set to 1, while when the parameter value f(m) is to be changed roughly, a change width δm is set to an integer value of more than 1 (step S6). In step S5, the processing advances to second selection processing when the drive waveform setting part 4 determines that the detected amount of ringing y(m) is smaller than the predetermined value yo (Yes in step S5).

Second selection processing is performed as follows. The drive waveform setting part 4 sets a range f(nₘᵢₙ) to f(nₘₐₓ) in which a parameter value f is changed and a change width δm of the parameter value. The range of the parameter value f is decided based on the parameter value f(m) when the amount of ringing y(m) becomes lower than the predetermined value yo acquired by the first selection processing. For example, on a condition that the minimum parameter value is set as f(nₘᵢₙ)=f(m+1), the range of the parameter value is set as f(nₘᵢₙ) to f(nₘₐₓ) and the change width is set as δn=1, selection processing can be performed in accordance with the order of the parameter values. Further, on a condition that the minimum parameter value is set as f(nₘᵢₙ)=f(m−x), the maximum parameter value is set as f(nₘₐₓ)=f(m+x) (x being an integer more than 1, and having the relationship of x<m), the range of the parameter value is set as f(m−x) to f(m+x), and the change width is set as δn, the parameter value around the parameter value f(m) which gives the amount of ringing y(m) lower than the predetermined value yo may be changed minutely.

The drive waveform setting part 4 reads waveform information W(nₘᵢₙ) corresponding to the parameter value f(nₘᵢₙ) (step S7). The drive waveform setting part 4 generates waveform data from the read waveform information W(n) and supplies the waveform data to the drive part 2. The drive part 2 generates a drive waveform based on the read waveform information and drives the optical scanner 10 (step S8). The detection part 5 detects an amount of ringing y(nₘᵢₙ) of the reflection part 6 by the detection element arranged on the optical scanner 10 (step S9) and stores the amount of ringing y(nₘᵢₙ) in the predetermined storage part. The drive waveform setting part 4 repeats the reading of the waveform information, the generation of the waveform data, the driving of the optical scanner 10 by the drive waveform, the detection of the amount of ringing and the storing of the amount of ringing while adding δn to n each time until n becomes nₘₐₓ (n=nₘₐₓ).

Next, the drive waveform setting part 4 specifies the parameter value f(nₓ) with which the amount of ringing becomes minimum (nₓ is an integer) out of the amount of ringing y(nₘᵢₙ) to the amount of ringing y(nₓ) which are stored in the predetermined region, and selects waveform information W(nₓ) corresponding to the parameter value f(nₓ) (step S12). The drive waveform setting part 4 generates waveform data from the selected waveform information W(nₓ) and supplies the waveform data to the drive part 2. The drive part 2 generates a drive waveform based on the waveform data, supplies the drive waveform to the optical scanner 10 to drive the optical scanner 10 (step S13), and the drive waveform setting processing is finished.

In the above-mentioned drive waveform setting processing, the first selection processing and the second selection processing are performed. However, the drive waveform may be set based on the parameter value f(m) selected in the first selection processing. That is, when the drive waveform setting part 4 detects that the amount of ringing y(m) detected in the first selection processing is smaller than the predetermined value yo (Yes in step S5), the drive waveform setting processing may be performed such that the second selection processing is omitted, and the waveform information W(m) with which the amount of ringing becomes minimum is selected (step S12) and the drive part 2 sets a drive waveform based on the waveform information and drives the optical scanner 10 using the set drive waveform (step S13).

It is also preferable that the change width δm in the first selection processing is set to a large value, while a change width 6n in the second selection processing is set to a small value. That is, as a parameter value corresponding to a physical quantity, a change width of the parameter value in the first selection processing is set coarse and the change width of the parameter value in the second selection processing is set fine. Due to such setting, a drive waveform with an optimum condition can be rapidly set. As has been explained in conjunction with FIG. 7, even when the amount of ringing y becomes lower than the predetermined value yo in the first selection processing, the rough relationship between the amount of ringing y and the parameter value f is obtained by further changing the parameter value f. Next, the parameter values f at two points where the amount of ringing y is close to the predetermined value yo or smaller than the predetermined value yo are obtained. Then, the second selection processing is performed. This processing may be performed such that a parameter value f(nₓ) which gives the lowest amount of ringing y(nₓ) is obtained by finely changing the parameter values f between these two points, and the drive waveform is obtained by specifying waveform information W(nₓ) corresponding to the parameter value. By properly setting the change widths δm, δn, it is possible to rapidly set a drive waveform with a decreased amount of ringing.

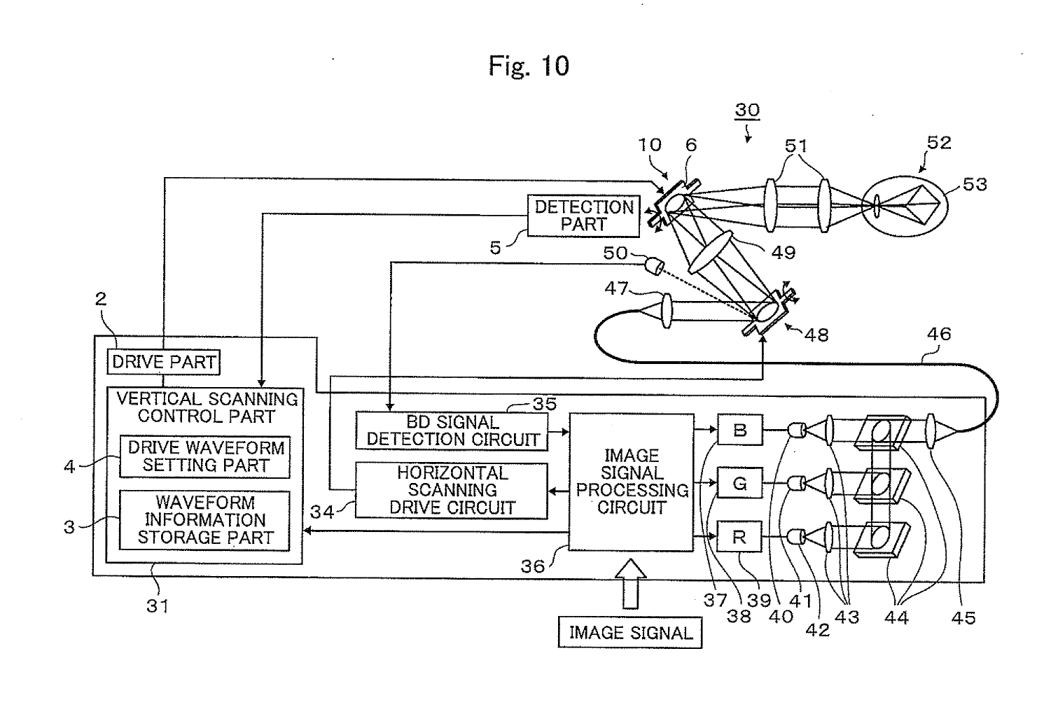

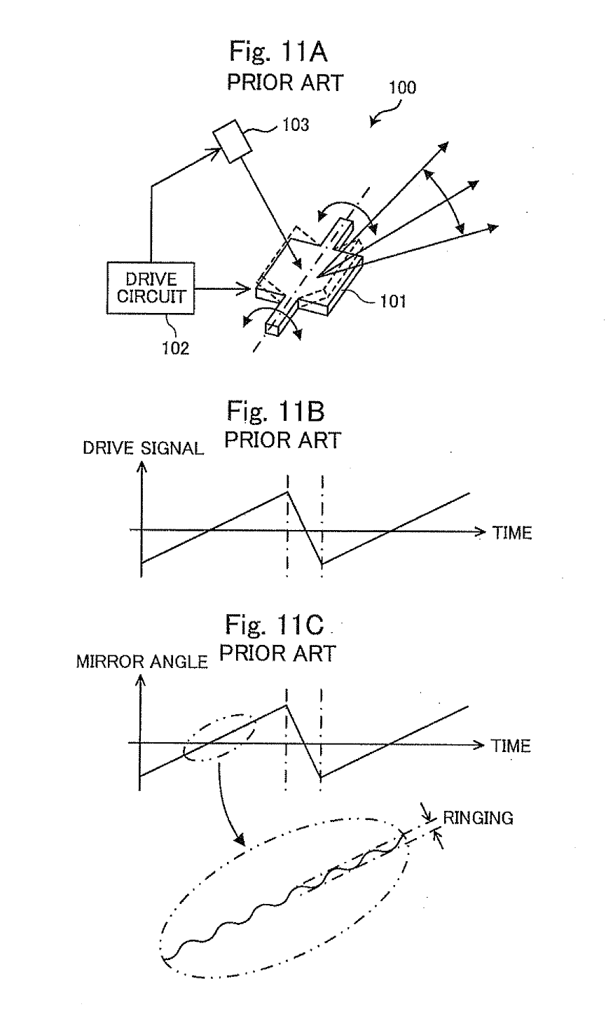

As shown in FIG. 10, a retinal scanning display 30 directly forms an image on a retina 53 of an eyeball 52 of a user. Hereinafter, the retinal scanning display 30 is explained specifically.

The image signal processing circuit 36 receives an image signal as an input and generates light source drive signals corresponding to blue (B), green (G) and red (R), and outputs the light source drive signals to a B laser drive circuit 37, a G laser drive circuit 38 and an R laser drive circuit 39 which constitute light source drivers. A B laser element 40 emits blue color whose light intensity is modulated corresponding to the blue color drive signal outputted from the B laser drive circuit 37, a G laser element 41 emits green color whose light intensity is modulated corresponding to a green color drive signal outputted from the G laser drive circuit 38, and an R laser element 42 emits red color whose light intensity is modulated corresponding to a red color drive signal outputted from the R laser drive circuit 39. Lights emitted from the respective laser elements are collimated to parallel lights by collimate optical systems 43, are synthesized by dichroic mirrors 44, are collected by a coupling optical system 45 and are incident on an optical fiber 46. An image light radiated from the optical fiber 46 is irradiated to a mirror of a high speed optical scanner 48 via a second collimate optical system 47.

A mirror portion of the high speed optical scanner 48 is swung by being driven by a horizontal scanning drive circuit 34 and scans a reflection light in the main scanning direction. The image light scanned in the main scanning direction is irradiated to the low speed optical scanner 10 which constitutes the optical scanning device of the present invention via a first relay optical system 49. In the low speed optical scanner 10, a mirror surface is swung due to a magnetic field so that a reflection light is scanned in the sub scanning direction. The image light reflected by the reflection part 6 of the low speed optical scanner 10 forms an image on the retina 53 of the eyeball 52 via the second relay optical system 51. Although the low speed optical scanner 10 is constituted such that all optical fluxes pass through the center of a pupil, the low speed optical scanner 10 may be constituted that the optical fluxes are converged such that the respective optical fluxes fall within the pupil. A beam detector (BD) 50 detects light scanned by the high speed optical scanner 48 and outputs the light to a BD signal detection circuit 35. An image signal processing circuit 36 receives the BD signal as an input from the BD signal detection circuit 35 and generates reference timing.

The image signal processing circuit 36 outputs a synchronization signal which is synchronized with the light source drive signal to the horizontal scanning drive circuit 34 and the vertical scanning control part 31. The high speed optical scanner 48 receives a horizontal drive waveform as an input from the horizontal scanning drive circuit 34 and swings the mirror portion thereof at a high speed using resonance oscillations.

The vertical scanning control part 31 is constituted of the drive waveform setting part 4 and the waveform information storage part 3. In the actual constitution, the vertical scanning control part 31 is constituted of a CPU (not shown in the drawing) which controls an operation of the vertical scanning control part 31, a ROM (not shown in the drawing) which stores a control program, a RAM (not shown in the drawing) which reads the control program, temporally stores the control program and is used as a working area and the like. The drive waveform setting part 4 is realized when the CPU executes the control program. The drive waveform setting part 4 executes the drive waveform selection processing at the time of starting the retinal scanning display 30 or at predetermined timing, and specifies waveform data for driving the low speed optical scanner 10. The drive part 2 receives the specified waveform data as an input, generates a drive waveform and drives the low speed optical scanner 10. The drive waveform is synchronized with the light source drive signal inputted from the image signal processing circuit 36. The detection part 5 detects an amount of ringing which is superimposed on the swinging by a swing detection element (not shown in the drawing) which is mounted on the reflection part 6 of the low speed optical scanner 10. The drive waveform setting part 4 selects waveform information with which the detected amount of ringing becomes equal to or less than the predetermined value yo and sets a drive waveform. The detail of the drive waveform selection processing has been already explained and hence, the detail of the drive waveform selection processing is omitted here.

Due to such constitution of the retinal scanning display 30, even when ringing to be superimposed on swinging of the low speed optical scanner 10 is influenced by the lapse of time or a change of environment, the drive waveform is automatically set so as to set an amount of ringing to a predetermined value or less and hence, it is possible to prevent lowering of quality of an image to be projected with time thus always ensuring a stable display of an image.

In this embodiment, the explanation has been made with respect to the case where the image display device is the retinal scanning display. However, by replacing the second relay optical system 51 with a projection optical system and by replacing the retina 53 with a screen which displays a projected image, a projection-type image display device can be used as the image display device.

What is claimed is:

1. An optical scanning device comprising:
a reflection part which is configured to scan a light beam by swinging;
a drive part which is configured to generate a drive waveform for swinging the reflection part;
a waveform information storage part which is configured to store a plurality of waveform informations used for the generation of the drive waveform;
a drive waveform setting part which is configured to select one waveform information from the plurality of waveform informations, and is configured to set the drive waveform based on the selected waveform information; and
a detection part which is configured to detect an amount of ringing which is formed of undesired oscillations contained in the swinging of the reflection part, wherein
the drive waveform setting part sequentially supplies the plurality of waveform informations stored in the waveform information storage part to the drive part, and selects the waveform information with which the detected amount of ringing becomes smaller than a predetermined value.

2. The optical scanning device according to claim 1, wherein the drive waveform has a sawtooth or triangular cyclic shape, and
the detection part detects the amount of ringing of the reflection part during an effective scanning period.

3. The optical scanning device according to claim 1, wherein the detection part includes a piezoelectric element which detects the swinging of the reflection part.

4. The optical scanning device according to claim 1, wherein the waveform information contains a frequency component in which a particular frequency component is suppressed,
the waveform information storage part stores a plurality of waveform information which differ from each other in the particular frequency, and
the drive waveform setting part sequentially supplies the waveform information which differ in the particular frequency to the drive part.

5. The optical scanning device according to claim 1, wherein the waveform information contains parameter values corresponding to a physical quantity which influences the oscillations of the reflection part, and
the drive waveform setting part sets a plurality of parameter values with which the physical quantity is changed roughly, sequentially supplies a plurality of waveform information corresponding to the plurality of set parameter values to the drive part, specifies a parameter value with which the detected amount of ringing becomes smaller than the predetermined value, sets a parameter value with which the physical quantity is changed finely based on the specified parameter value, supplies waveform information corresponding to the set parameter value to the drive part, and selects waveform information with which the detected amount of ringing becomes minimum.

6. The optical scanning device according to claim 5, wherein the drive waveform setting part sets a plurality of parameter values with which the physical quantity is changed finely, and sequentially supplies a plurality of waveform information corresponding to the plurality of set parameter values to the drive part.

7. An image display device comprising:
a low-speed optical scanning device which comprises:
i) a reflection part which is configured to scan a light beam by swinging;
ii) a drive part which is configured to generate a drive waveform for swinging the reflection part;
iii) a waveform information storage part which is configured to store a plurality of waveform informations used for the generation of the drive waveform;
iv) a drive waveform setting part which is configured to select one waveform information from the plurality of waveform informations, and is configured to set the drive waveform based on the selected waveform information; and
v) a detection part which is configured to detect an amount of ringing which is formed of undesired oscillations contained in the swinging of the reflection part, wherein the drive waveform setting part sequentially supplies the plurality of waveform informations stored in the waveform information storage part to the drive part, and selects the waveform information with which the detected amount of ringing becomes smaller than a predetermined value;
a high speed optical scanning device;
a light source which is configured to generate a light beam whose intensity is modulated based on an image signal and is configured to irradiate the light beam to the optical scanning device; and
a projection lens system which is configured to project the light beam scanned by the optical scanning device.

8. A method of driving an optical scanning device which comprises: a reflection part which is configured to scan a light beam by swinging; a drive part which is configured to generate a drive waveform for swinging the reflection part; a waveform information storage part which is configured to store a plurality of waveform informations used for the generation of the drive waveform; a drive waveform setting part which is configured to select one waveform information from the plurality of waveform informations, and is configured to set the drive waveform by supplying the selected waveform information to the drive part; and a detection part which detects an amount of ringing which is oscillations superimposed on the swinging of the reflection part, the method comprising the steps of:
reading the plurality of waveform information stored in the waveform information storage part;
swinging the reflection part by supplying the read waveform information;
comparing the amount of ringing detected by the detection part and a predetermined value and selecting the waveform information when the detected amount of ringing becomes smaller than the predetermined value; and
driving the reflection part by setting the selected waveform information in the drive part.
